(19) United States
(12) Patent Application Publication
(10) Pub. No.: US 2017/0318218 A1
(43) Pub. Date: Nov. 2, 2017

(54) SLOW-MOTION DEVICE

(71) Applicant: Felix Schelhasse, Bonn (DE)

(72) Inventor: Felix Schelhasse, Bonn (DE)

(21) Appl. No.: 15/498,532

(22) Filed: Apr. 27, 2017

(30) Foreign Application Priority Data
Apr. 28, 2016 (DE) 20 2016 102 254.1

(51) Int. Cl. H04N 5/232; H04N 5/225; G06T 7/70; H04L 29/08; H04N 5/907

(52) U.S. Cl. CPC H04N 5/23216; H04N 5/907; H04N 5/23293; H04N 5/2254; G06T 7/70; H04L 67/02; H04N 5/2252; G06T 2207/10016

(57) ABSTRACT

The invention relates to a device for detecting, storing and displaying digital images having an image acquisition unit for acquiring an image sequence of an object arranged in the detection field of the image acquisition unit, a storage unit for saving the image sequence of the object, a display unit for displaying the image sequence and a control unit for controlling the image acquisition unit, the storage unit and/or the display unit. The control unit acts on the image acquisition unit with image control means such that during a given image acquisition interval, the image sequence detected by the image acquisition unit is provided as a slow-motion image sequence to the storage unit. The same is displayed on the display unit, and can be saved in the storage unit. Thereby, the memorable nature of a celebration is further increased.

The invention relates to a device for detecting, storing and displaying digital images having an image acquisition unit for acquiring an image sequence of an object arranged in the detection field of the image acquisition unit, a storage unit for saving the image sequence of the object, a display unit for displaying the image sequence and a control unit for controlling the image acquisition unit, the storage unit and/or the display unit.

A device for detecting, storing and displaying digital images, which comprises an image acquisition unit, a storage unit, a display unit and a control unit, is known from DE 10 2009 034 266 B4. In addition, an image evaluation unit is provided, which is configured such that digital images or image sections of objects, in particular of passersby, are generated, which are dependent on dominant movements of the object previously detected by the image acquisition unit. This creates a strong attention stimulus for the viewer, prompting him to view the image shown as such. The image thus displayed can be used for marketing purposes. However, the display unit or the known device is not intended to display an image sequence.

In addition, the process of setting up an arrangement consisting of a camera and a backdrop, between which one or more persons can position themselves, in order to increase the memorable nature of a special occasion, for example a wedding, company celebrations, etc. is known. Digital images can be generated by activating the image acquisition unit, which can subsequently be provided to the corresponding person via the internet.

The object of the present invention is to further develop a device for detecting, storing and displaying digital image sequences such that an additional opportunity is provided for increasing the memorable nature of a special occasion.

In order to achieve this object the invention in conjunction with the preamble of claim 1 is characterized in that the control unit acts on the image acquisition unit with image control means such that during a given image acquisition interval, which is dependent on an acquisition time point specified by a user, the image sequence detected by the image acquisition unit is provided as a slow-motion image sequence to the storage unit and the same is displayed on the display unit, and that the generated slow-motion image sequence can be saved in the storage unit, and that the image acquisition unit, the storage unit, the display unit and the control unit are arranged in a common housing.

The particular advantage of the invention is that the memorable nature of a celebration is further increased. In particular, the fun nature of the event is increased by means of the slow-motion image sequence generated. The user can move in a particular way, for example dance, during the specified image acquisition interval, with these movements being stored as a slow-motion image sequence and/or played back to him. The user can then decide whether this slow-motion image sequence has, in his opinion, the necessary memorable nature. If it does, this slow-motion image sequence can be subsequently made available to the user, for example via the internet, or by burning a DVD. Since the modular units of the device are arranged in a common housing, the device has a compact, self-contained design. It simply requires access to an electrical outlet, if no battery is integrated into the device. The user can advantageously actuate the device himself, without requiring somebody else to supervise the process. The fact that the modular units are housed in a common housing means the device is portable and easy to use.

According to a preferred embodiment of the invention, the image acquisition and display unit can be controlled such that a current image of the object is displayed on the display unit up to the activation time point. As a result, a current image of the object can advantageously be shown so that the object, in particular persons, can position themselves within a detection field of the image acquisition unit.

According to a preferred embodiment of the invention, the storage and display unit can be controlled such that, following the image acquisition interval, the determined slow-motion sequence is automatically shown on the display unit. The user can therefore advantageously check relatively quickly whether the acquired slow-motion image sequence has the required memorable nature or not. If it does, measures can be taken to send the slow-motion image sequence to the user.

According to a preferred embodiment of the invention, the image acquisition interval is fixed. For example, it can be 10 seconds, which is indicated to the user, for example, by means of a sign attached to the housing. As a result, the control effort can be kept relatively low.

According to a further development of the invention, the control unit acts on the acquired image data such that the slow-motion image sequences are successively stored under differently named video files in the storage unit. The desired slow-motion image sequence can easily be subsequently located, for example by linking said image sequence with a time indication.

According to a further development of the invention, the control unit comprises selection control means so that stored and subsequently displayed slow-motion image sequences are deleted at the request of the user. This can advantageously increase data protection.

According to a further development of the invention, the display unit comprises a monitor for reproducing the slow-motion image sequence and a signal generator for indicating a current image acquisition. This improves the ease of handling and/or evaluating the slow-motion image sequence.

According to a further development of the invention, an activation unit is provided such that the user can select when to start the image acquisition in a self-determining manner.

According to a further development of the invention, the housing is configured as a polyhedron with six sides. The housing therefore constitutes a box which is easy to transport and erect.

Other advantages of the invention are set out in the additional subordinate claims.

One embodiment example of the invention is explained in more detail below, with reference to the drawings, wherein:

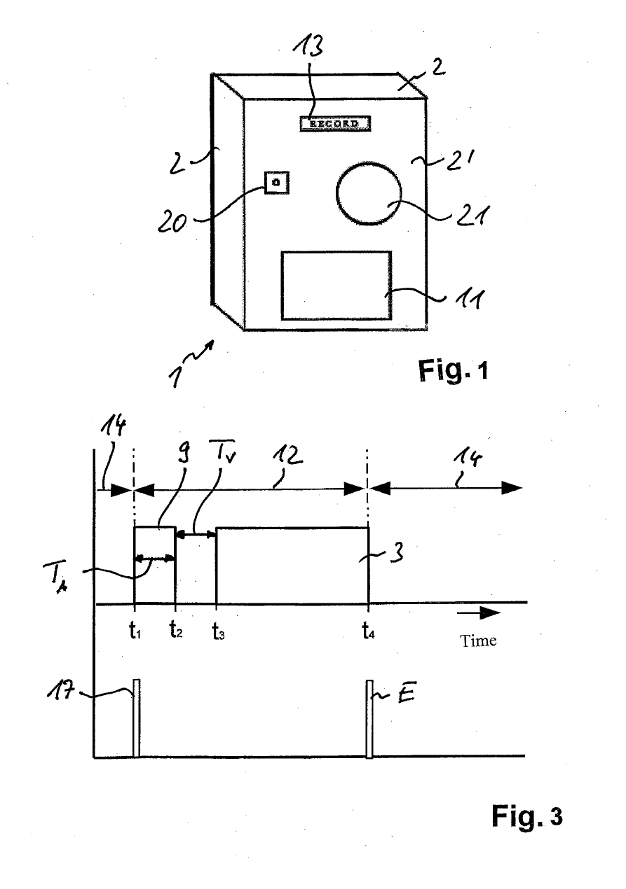

FIG. 1 shows a perspective front view of a device according to the invention,

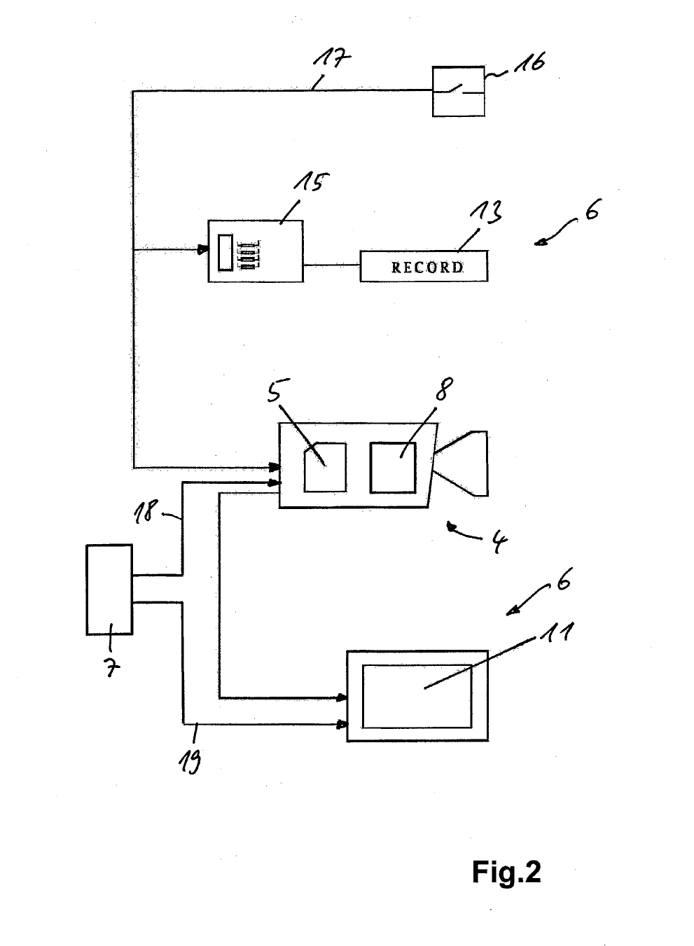

FIG. 2 shows a schematic representation of components of the device according to the invention,

FIG. 3 shows a time chart, and

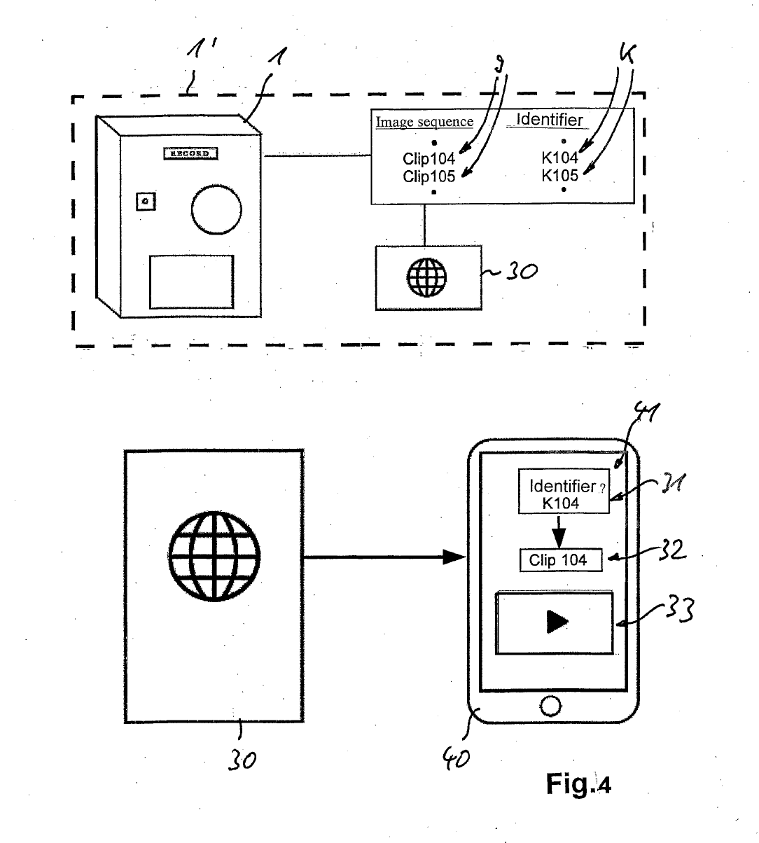

FIG. 4 shows a block diagram in order to show a further use of the detected image sequences.

A device according to the invention for detecting, storing and displaying digital images is configured as a polygonal housing 1 with six sides 2. The housing 1 is preferably cube-shaped or configured as a cube.

The device according to the invention is intended to be used at events such as, for example, weddings, company celebrations, exhibitions, etc. in order to give users an opportunity to generate a slow-motion image sequence 3.

As shown in FIG. 2, the device substantially comprises an image acquisition unit 4 for acquiring image sequences of an object arranged in a detection area of the same, a storage unit 5 for saving an image sequence of the object, a display unit 6 for displaying the image sequence and a control unit 7 for controlling the image acquisition unit 4 and/or the storage unit 5 and/or the display unit 6.

The image acquisition unit 4 is preferably configured as a video camera, into which a slow motion generator 8 is integrated, so that the slow-motion image sequence 3 is generated at the same time as an image sequence 9 is acquired.

The storage unit 5, in which the slow-motion image sequence 3 is stored, can be configured such that it is integrated into the image acquisition unit 4 as, for example, a memory card.

The display unit 6 includes a monitor 11 for reproducing the slow-motion image sequence 3 after the images have been acquired in an acquisition/playback mode 12 and for reproducing a real-time image detected by the image acquisition unit 4 in a real-time mode 14 of the device. In addition, the display unit comprises a signal generator 13 for indicating the acquisition of an image or the non-acquisition of an image. The signal generator 13 can be configured, for example, as a red light which is controlled by time switching electronics 15.

In addition, an activation unit 16 is provided, which can be actuated by the user and by means of which an activation signal 17 is generated to the signal generator 13 and the image acquisition unit 4. As soon as the user has actuated the activation unit 16, the device changes its state from the real-time mode 14, in which current images of the detection field of the image acquisition unit 4 are exclusively displayed on the monitor 11, to the acquisition/playback mode 12, which starts at time t₁ with the acquisition of an image sequence by means of the image acquisition unit 4. The activation signal 17 can be sent directly to the signal generator 13 and the image acquisition unit 4. Alternatively, the activation signal 17 can also be transmitted to the control unit 7, from which the image acquisition unit 4 and/or the storage unit 4 and/or the monitor 11 are controlled.

The control unit 7 preferably comprises a microprocessor or microcontroller which controls the image acquisition unit 4 via the image control means 18 (image control signal) and the monitor 11 by means of image display means (image display signal 19).

According to an alternative embodiment of the invention, the control unit 7 can also be integrated into the image acquisition unit 4.

As shown in FIG. 3, when it is switched on, the device is either located in the real-time mode 14 or in the acquisition/playback mode 12. In the real-time mode 14, only the actual object located in the detection field of the image acquisition unit 4 and/or at least one person is/are recorded and shown as an image sequence on the monitor 11. To this end, the control unit 7 comprises suitable image control means which act on the image acquisition unit 4 and the monitor 11, so that the image sequence is virtually shown as a live image.

The acquisition/playback mode 12 is started by the user by actuating the activation device 16. To this end, the activation device 16 can comprise an actuating element, for example a button 20 on a front side 2′ of the housing 1. The acquisition of the image sequence 9 starts when the activation button 20 is actuated at time t₁, wherein said image sequence is stored in the storage unit 5. Images are acquired for a fixed image acquisition interval TA of, for example, 10 seconds. The image acquisition interval TA is fixed and cannot be altered. The image acquisition stops after the image acquisition interval TA at time t₂. After a delay interval Tv of, for example, a few seconds, the acquired image sequence 9 is played back and shown on the monitor 11 as a slow-motion image sequence 3. The delay interval Tv is also fixed. The slow-motion image sequence 3 starts at time t₃ and ends at time t₄, the difference of which is greater than the image acquisition interval TA. Once the slow-motion image sequence 3 has finished being shown, the control unit 7 generates a real-time signal E so that the device switches from the image acquisition/playback mode to the real-time mode. By generating a further activation signal 17 by means of the activation button 20, the device can then be switched over from the real-time mode to the acquisition/playback mode.

In addition to the activation button 20, a lens front side 21 of the image acquisition unit 4, a front side of the monitor 11 and the signal generator 13 are located on the front side 2′ of the housing 1. All of the input/output means required for the operation of the device are therefore located on the front side 2′. The slow-motion image sequences 3 stored in the storage unit 5 are saved as video files. If the image acquisition unit 4 is Wi-Fi enabled, said files can be transferred to an external computer, so that these files can be made available to the user, for example via the internet. Alternatively, the memory card of the storage unit 5 can be removed from the image acquisition unit 4 and inserted into a computer, by means of which the video files are accessible to users over the internet.

According to an alternative embodiment of the invention, the slow-motion generator 8 can also be arranged outside the image acquisition unit 4.

The slow-motion generator 8 is configured such that the acquired image sequence 9 is played back in a slowed down manner and is stored as a video file in the storage unit 5.

According to one embodiment, the control unit comprises control means, so that the slow-motion image sequence which is stored and played back on the display unit can be deleted at the request of the user.

According to an alternative embodiment of the invention (which is not shown), a camera can additionally be integrated into the image acquisition unit 4 in order to acquire individual images, the acquisition of which can be activated by the user by means of the activation button 20 or an additional button. These individual photographs can be acquired before, during or after the acquisition of the slow-motion image sequence 3. In this way, not only moving images, but also stationary images are available to the user.

According to a further embodiment of the invention in accordance with FIG. 4, a device 1 for providing digital images and/or image sequences or photographs is provided, wherein these image sequences 3 and/or photographs have been detected, stored and displayed by the device 3 described above. The image sequence 9 (slow-motion sequence and/or photographs) can be provided to the users relatively quickly and easily by means of the device 1′ shown in FIG. 4. For this purpose, an evaluation unit is integrated into the housing 1, which makes possible means for providing identifiers K104, K105 which are assigned in each case to the image sequences 9 (slow-motion image sequence, photographs). An identifier K is assigned to each image sequence 9, for example a slow-motion image sequence/clip, by means of which identifier the image sequence can be assigned to a user. The image sequence 9 is identified with the number 104 and stands for an acquisition date and acquisition time. In order to ensure that said image sequence with the number clip 104 can be assigned to a user, this image sequence clip 104 is given an identifier K 104, which can be displayed on the display unit 8 of the device 1 or on a display unit (display) which is outside the housing 1. Alternatively, this identifier K can also be printed out automatically or at the request of the user by a printer integrated into the housing 1 as a sheet provided with the identifier.

A communication module is preferably integrated into the housing 1, which makes possible means for uploading the image sequences from the storage unit 5 and/or the image acquisition unit 4 to a web server 30. The communication module can, for example, be configured as a LAN module or Wi-Fi module, which makes it possible to either upload image sequences directly to the web server 30 or to upload image sequences, with a time delay, to the web server 30. The image sequences can be uploaded by means of a prompt from the user or independently of the user.

The web server 30 is operated by the service provider of the slow-motion video box 1, 1′ and makes it possible for users to access the created image sequences 9 and, if necessary, download them after registering on the web server 30.

According to an alternative embodiment of the invention, the image sequences assigned to the user can also be provided by means of an application 41 which is loaded onto a mobile phone 40 (“slow-motion loading app”). It goes without saying that the user is registered for this slow-motion loading app 41 and has also recorded his account data, in order to purchase the download of the image sequences. The user can, for example, pay for the slow-motion loading app 41 and/or pay a price for each downloaded image sequence 3. The essential thing is that the user only has access to the image sequences initiated by him. This is guaranteed in that the identifier K104, K105 corresponding to the image sequences initiated by him clip 104, clip 105 has been displayed and/or printed out or transferred directly to his mobile phone 40, for example via Bluetooth or Wi-Fi. After opening the slow-motion loading app 41, the program prompts the user to enter an identifier which has been assigned to him—step 31. Once he has entered this identifier K, using K104 as shown, for example, in FIG. 4, the image sequence with the number clip 104 assigned to this identifier is shown in step 32, which can then be downloaded in a further step 33 to the mobile phone 40. Since the downloaded image sequence exists in a standard MP4, jpg format, the slow-motion sequence and/or the photograph can be easily further used, for example forwarded to friends and acquaintances. A further authorization can also be carried out as an admissibility requirement. For example, at least one image sequence 9 which is produced at certain periods of time can be assigned to a group of users and can be provided on the web server 30 as a function of an authorized registration.

The device 1′ shown in FIG. 4 advantageously makes it possible to quickly and easily provide the image sequences initiated by the respective users to the respective users and/or the respective authorized users. The confidentiality of the image sequences is ensured in that the identifier is only provided within a certain period of time, namely within a time interval following the image sequence initiated by the user and/or by printing out the identifier. This identifier which is preferably generated by means of a random generator prevents strangers or unauthorized persons from gaining access to the image sequences.

1. A device for detecting, storing and displaying digital images having
an image acquisition unit (4) for acquiring an image sequence (9) of an object arranged in the detection field of the image acquisition unit (4),
a storage unit (5) for saving the image sequence of the object,
a display unit (6) for displaying the image sequence, and
a control unit (7) for controlling the image acquisition unit (4), the storage unit (5) and/or the display unit (6), wherein
the control unit (7) acts on the image acquisition unit (4) with image control means such that during a given image acquisition interval (T), which is dependent on an activation time point (t₁) specified by a user, the image sequence (9) detected by the image acquisition unit (4) is provided as a slow-motion image sequence (3) to the storage unit (5) and the same is displayed on the display unit (6) and the generated slow-motion image sequence (3) can be stored in the storage device (5), and
the image acquisition unit (4), the storage unit (5), the display unit (6) and the control unit (7) are arranged in a common housing (1).

2. The device according to claim 1, wherein the control unit (7) acts on the image acquisition unit (4) and/or the display unit (6) such that a current image of the detection area detected by the image acquisition unit (4) is displayed up to the activation time point (t₁).

3. The device according to claim 1, wherein the control unit (7) acts on the storage unit (5) and/or the display unit (6) such that the generated slow-motion image sequence (3) is automatically shown on the display unit (6) after the image acquisition interval (T_{A}).

4. The device according to claim 1, wherein the image acquisition interval (T_{A}) is fixed.

5. The device according to claim 1, wherein the control unit (7) acts on the storage unit (5) such that the slow-motion image sequences (3) are successively stored as differently named video files.

6. The device according to claim 1, wherein the control unit (7) comprises control means, so that the slow-motion image sequence (3) stored and played back on the display unit (6) can be deleted at the request of the user.

7. The device according to claim 1, wherein the display unit (6) comprises a monitor (11) for reproducing the current image sequence (9) and the slow-motion image sequence (3), and a signal generator (13) for indicating the acquisition of the image sequence (9).

8. The device according to claim 1, wherein an activation unit (16) is provided, by means of which the image acquisition can be started at the acquisition time point (t₁).

9. The device according to claim 1, wherein the activation unit (16) comprises an actuating element (20) which is arranged on a front side (2′) of the housing (1).

10. The device according to claim 1, wherein a lens (21) of the image acquisition unit (4) and a display area of the monitor (11) are arranged on the front side (2′) of the housing (1).

11. The device according to claim 1, wherein the housing (1) is configured as a polyhedron with six sides (2).

12. The device according to claim 1, wherein the housing (1) is configured as a cube.

13. The device according to claim 1, wherein the image acquisition unit (4) additionally comprises a camera for acquiring individual images.

14. A device for providing image sequences (9) which are created with a device for detecting, storing and displaying digital images according to claim 1, further comprising at least one of:
means for uploading the image sequences (9) from the storage unit (5) and/or from the image acquisition unit (4) to a web server (30),
means for providing identifiers (4) assigned to each of the image sequences (9) to the users of the image sequences (9) initiated by them, and
means for downloading the image sequences (9) from the web server (30) to a data store of the user by the same as a function of the identifier (K) assigned to the user and/or an admissibility requirement.

15. The device according to claim 14, wherein the image sequences (9) can be transferred by means of an application (41) which can be run on a mobile phone (40) from the web server (30) to a memory of the mobile phone (40), wherein the user enters the identifier (K) assigned to the image sequence (9) in order to download the image sequence (9).
